(19) United States
(12) Patent Application Publication
(10) Pub. No.: US 2021/0394114 A1
(43) Pub. Date: Dec. 23, 2021

(54) DEVICES FOR HARVESTING DRINKING WATER FROM AIR USING SOLAR ENERGY AND HEAT RECUPERATION

(71) Applicant: X Development LLC, Mountain View, CA (US)

(72) Inventors: Philipp H. Schmaelzle, Mountain View, CA (US); Shane Washburn, Oakland, CA (US); Neil David Treat, San Jose, CA (US); Matthew Sakae Forkin, San Mateo, CA (US); Finn Carlsvi, Santa Clara, CA (US); Claudia Truesdell, Palo Alto, CA (US); Alexandra Galila Ramadan, Cupertino, CA (US); Adi Cathy Aron-Gilat, Menlo Park, CA (US); Jackson Lord, San Francisco, CA (US); Nicole Kobilansky, San Francisco, CA (US); Matthew David Day, Oakland, CA (US); Nicholas John Foster, Oakland, CA (US); Joseph Hollis Sargent, San Francisco, CA (US); Julie Hanna, San Francisco, CA (US); Cyrus Behroozi, Menlo Park, CA (US); David Youmans, San Francisco, CA (US)

(21) Appl. No.: 17/211,690

(22) Filed: Mar. 24, 2021

(51) Int. Cl. B01D 53/26; B01D 53/06; E03B 3/28

(52) U.S. Cl. CPC B01D 53/265; B01D 53/06; B01D 53/261; B01D 2259/45; B01D 2257/80; B01D 2259/4009; E03B 3/28

(57) ABSTRACT

Devices and methods for atmospheric water harvesting may be useful to obtain drinking water from air of moderate humidity, in a process driven directly by solar energy. Devices feature a recirculating stream of a fluid, such as air, and include heat recuperation to heat fluid in one portion of the stream using heat contained in another portion of the stream. Passive heat sinking is sufficient to condense liquid water, without need for refrigeration. The objective of the technologies and inventions is to enable affordable household products that improve drinking water access, with a focus on those currently without access to safely managed drinking water.

### FIELD

This application relates to atmospheric water harvesting, and more particularly to continuous mode atmospheric water harvesting for producing potable water using solar energy and heat recuperation.

### PLEDGE

Lack of access to safely managed drinking water still affects a large fraction of the world's population. Through the creation and disclosure of the technology described herein, X and the listed inventors seek to make a positive impact in combating water insecurity around the world.

Accordingly, X hereby pledges not to assert this patent against:
any human being (an “Individual”) end user of an atmospheric water harvesting device for individual water consumption or daily water use,
any Individual DIYer, tinkerer, or maker of all or part of an atmospheric water harvesting device that is used for water consumption or daily water use by an Individual end user, or
any Individual or entity using the patent to conduct non-commercial research in the field of atmospheric water harvesting.

In the unanticipated event this patent is assigned to a different assignee, it is X's sincere hope that future assignees continue this pledge.

Applications of the disclosed technology also may benefit emergency responses to humanitarian crises. Accordingly, should any entity desire to leverage the disclosed technology when responding to a humanitarian crisis, royalty-free licenses may be available on a case-by-case basis. The assignee invites any such entity to contact them to inquire about such licenses.

### BACKGROUND

According to the WHO/JMP Joint Monitoring program, 2.2 billion people lack access to safely managed drinking water. (Safely managed drinking water is defined as water that is located on premises, available when needed and free from faecal and priority chemical contamination.) This population lacks access despite the huge renewable water resource that exists in atmospheric water, the water that forms clouds, fog, and water vapor in the air. Atmospheric water harvesting refers to the process of harvesting this atmospheric humidity.

Current atmospheric water harvesting methods include radiative cooling, and sorption-based water collecting. Sorption-based water collectors generally use a desiccant material to capture water from the air. Subsequent heating of the desiccant releases (desorbs) the water from the desiccant into a working fluid (in this case air), concentrating humidity in that fluid. The fluid is then cooled to below dew point, where the water vapor condenses and can be collected as liquid water.

### SUMMARY

This disclosure features continuous mode atmospheric water harvesting devices for producing potable water. The water harvesting devices work to continuously condense atmospheric water during daylight hours, in contrast to diurnal mode atmospheric water harvesting devices that use a single night-day cycle. A diurnal mode atmospheric water harvesting device absorbs ambient humidity from the atmosphere onto the desiccant at night. It then uses daytime solar energy to heat the desiccant, desorbing the vapor from the desiccant to the working fluid, and then condenses the vapor to liquid water when cooled below the dew point. Continuous mode atmospheric water harvesting devices follow a similar process but do not depend on day/night temperature cycling. Instead they utilize multiple daytime cycles to absorb ambient humidity, desorb it into a working airstream, cool it to below dew point, and collect the condensed liquid water.

Generally, the disclosed atmospheric water harvesting devices feature a recirculating stream of air (or other gas) that is heated, humidified (e.g., by passing through a desiccant that has been exposed to water vapor), cooled to condense and harvest the water vapor, and then reheated to repeat the cycle. The water for rehumidification is provided by a humidity stream, which can provide water vapor from an ambient environment to a desiccant, for example.

In some embodiments, rehumidification is performed using a cycled desiccant mechanism in which a desiccant is used to move moisture from the humidity stream to the recirculating stream, driven by a difference in temperature between the two streams. In certain embodiments, the desiccant is a solid desiccant material in a desiccant module. The desiccant module is configured to move desiccant material between two fluid paths. For example, the desiccant module can be a wheel or drum that is rotated continuously between two fluid paths that are isolated from one another. One path contains a humidity supply stream of air. For example, this path can be open to the environment, drawing air in from the atmosphere. The desiccant absorbs water vapor from the humidity supply stream as the air stream passes over the desiccant material. The other path is for the recirculating stream, which is sufficiently heated at the desiccant module to cause desorption of water from the desiccant material, increasing the humidity level of the recirculating stream. Subsequently, the heated, humid gas in the recirculating stream is cooled to dew point, condensing the water vapor, which is collected and delivered to a storage vessel.

In certain embodiments, heat is recuperated from the recirculating stream. For example, heated, humid air and cooled, dry air in the recirculating stream can be passed through a heat exchanger in which thermal energy is transferred from the heated air to the cooled air. Such heat recuperation can improve the overall efficiency of the atmospheric water harvesting devices.

In general, in a first aspect, the disclosure features an atmospheric water harvesting device including: a humidity stream path arranged to receive air from an ambient environment to provide a humidity stream; a recirculating stream path for a recirculating stream of a fluid, the recirculating stream path being separated from the humidity stream path; a heating section in the recirculating stream path, the heating section being configured to heat the fluid in the recirculating stream path as it moves through the heating section during operation of the atmospheric water harvesting device; a rehumidification section in the recirculating stream path, and a humidity transfer section in the humidity stream path, the rehumidification section being arranged to receive the fluid in the recirculating stream path from the heating section (e.g., directly from the heating section or via one or more intermediate sections) and configured to transfer moisture from the air in the humidity stream to the fluid in the recirculating stream during operation of the atmospheric water harvesting device; a recuperator section in the recirculating stream path, the recuperator section being configured, during operation of the atmospheric water harvesting device, to transfer thermal energy from the fluid in the recirculating stream prior to the fluid entering the condensing section to the fluid in the recirculating stream after the fluid exits the condensing section; and a condensing section in the recirculating stream path, the condensing section being configured to transfer thermal energy from the fluid in the recirculating stream sufficient to cause condensation of water from the fluid during operation of the atmospheric water harvesting device.

Embodiments of the atmospheric water harvesting device can include one or more of the following features and/or features of other aspects. For example, the heating section can include a solar heater. The solar heater can include a sunlight absorbing material exposed to ambient radiation and in thermal contact with (i.e., sufficient to transfer significant thermal energy to the fluid in the heating section, e.g., in physical contact with) the recirculating stream path in the heating section. The solar heater can include a transparent window separating the recirculating stream from the ambient environment. The transparent window can include one or more spectrally selective coatings configured to reduce loss of heat by infrared radiation from the recirculating stream in the heating section to the ambient environment. In some embodiments, the heating section includes one or more stagnant blanket layers configured to reduce thermal losses of the recirculating stream in the heating section. The heating section can include one or more flowing blanket layers configured to reduce thermal losses (e.g., by providing thermal insulation) of the recirculating stream in the heating section. The one or more flowing blanket layers can include fluid from the recirculating stream after the fluid has exited the rehumidification section.

In embodiments where the transparent window is formed from a plastic film or otherwise flexible top glazing layer, small holes or orifices can be added between two film layers. These holes can allow the pressurized recirculated flow to move into the blanket layer such that the glazing of the heating section remains flat for uniform fluid flow, and the blanket layer can slightly expand/bulge and bear any differential pressure between the fluid and ambient air. The same strategy can be employed wherever spaces of different pressures are adjacent. It reduces forces on the fluid-containing space, deformation of which can lead to mechanical issues and affect flow distribution negatively. In result, it is a way to reduce material thicknesses and strengths while preserving performance, and thus aids the goal of making atmospheric water harvesting devices more affordable.

In some embodiments, the solar heater includes one or multiple layers of mesh material. These mesh layers can increase the absorption and scattering of sunlight, increase heated surface area, fluid turbulence and uniform distribution for improved performance.

The rehumidification section can include a cycled desiccant mechanism to facilitate transfer of moisture from the humidity stream to the recirculating stream during operation of the atmospheric water harvesting device. The cycled desiccant mechanism can include an assembly comprising a desiccant material and a motor configured to move the desiccant material between the path of the recirculating stream and the path of the humidity stream. The assembly can include a desiccant wheel assembly configured to rotate the desiccant material between the path of the recirculating stream and the path of the humidity stream. In some embodiments, the assembly includes a support for the desiccant material, the support being selected from at least one of a belt, a cylinder, or a cone.

A first compartment of the recuperator section can be located in the recirculating stream path immediately downstream from the rehumidification section (i.e., without another section in recirculating stream path between) and immediately upstream from the condensing section and a second portion of the recuperator section. A second compartment of the recuperator section can be located in the recirculating stream path immediately upstream from the condensing section and immediately downstream from the heating section.

The recuperator section can include a heat exchanger module including a first flow path for the recirculating stream and a second flow path for the recirculating stream separated from the first flow path, the first flow path being arranged in the recirculating stream path downstream from the rehumidification section and upstream from the condensing section, and the second flow path being arranged in the recirculating stream path downstream from the condensing section and upstream from the rehumidification section.

The recuperator section can include a foil separating fluid in the recirculating stream path downstream from the rehumidification section and upstream from the condensing section from fluid in the recirculating stream path downstream from the condensing section and upstream from the rehumidification section.

The condensing section can be configured to transfer thermal energy from the fluid in the recirculating stream by transferring thermal energy from the fluid to air at an ambient temperature. The condensing section can include a heat exchanger arranged to transfer thermal energy from the fluid in the recirculating stream to the air at ambient temperature. The atmospheric water harvesting device can include a blower arranged to direct air from the ambient environment through one or more ducts in the condensing section. In some embodiments, the condensing section includes a barrier separating the fluid in the recirculating stream from the ambient environment, wherein the transfer of thermal energy takes place through the barrier.

The atmospheric water harvesting device can include a heat sinking section arranged in the recirculating stream path between the recuperator section and the condensing section, the heat sinking section being configured to transfer thermal energy from the fluid in the recirculating stream to an ambient environment. The heat sinking section can include a passive heat sink.

The atmospheric water harvesting device can include one or more blowers to move the fluid through the recirculating stream path.

The atmospheric water harvesting device can include a water trap to facilitate extraction of liquid water condensed in the condensing section.

In some embodiments, the atmospheric water harvesting device includes a photovoltaic module configured to provide electrical power to components of the atmospheric water harvesting device.

The atmospheric water harvesting device can have a mass of 50 kg or less (e.g., 40 kg or less, 30 kg or less, 20 kg or less).

In general, in a further aspect, the disclosure features a method for harvesting water from air, the method including: directing a fluid continuously in a recirculating stream; heating the fluid in a first section of the recirculating stream; after heating the fluid, transferring water vapor from a humidity stream to the working fluid in a second section of the recirculating stream, the humidity stream including air from an ambient environment; after transferring the moisture to the working fluid in the recirculating stream, cooling the working fluid sufficiently to cause condensation of liquid water from the working fluid in a third section of the recirculating stream; collecting the liquid water; and directing the working fluid from the third section of the recirculating stream back to the first section of the recirculating stream. Cooling the fluid and heating the fluid can include transferring thermal energy through a fluid barrier from the fluid in the third section to the fluid in the first section.

Implementations of the method can include one or more of the following features and/or features of other aspects. For example, the fluid can be heated with solar energy. For a relative humidity of 30% or more of the ambient environment, water can be collected at a rate of 100 ml/hour or more per square meter of exposure to solar energy. (e.g., 120 ml/hour or more, 150 ml/hour or more, 200 ml/hour or more, 300 ml/hour or more, 400 ml/hour or more).

Transferring the water from the humidity stream to the recirculating stream can include exposing a desiccant to the humidity stream under conditions sufficient for the desiccant to absorb water from the humidity stream and subsequently exposing the desiccant to the recirculating stream under conditions sufficient for the water to desorb from the desiccant. Transferring the water can include moving the desiccant from the humidity stream to the recirculating stream. Moving the desiccant includes rotating a wheel assembly supporting the desiccant between the humidity stream to the recirculating stream.

Heat recuperation can be achieved by transferring the thermal energy through the fluid barrier from the recirculating fluid in the third section to the recirculating fluid in the first section and directing the fluid in the third section through a heat exchanger.

The recirculating fluid in the first section can be heated to 60° C. or more (e.g., 65° C. or more, 70° C. or more, 75° C. or more, 100° C. or more, 120° C. or more, such as up to 150° C.). The recirculating fluid in the first section can be heated to 100° C. or less. (e.g., 90° C. or less, 80° C. or less, 70° C. or less).

The recirculating fluid can be cooled in the third section to 50° C. or less (e.g., 45° C. or less, 40° C. or less). The recirculating fluid can be cooled in the third section to no less than ambient (e.g., 2° C. more than ambient, 5° C. more than ambient, 10° C. more than ambient).

The recirculating fluid can be directed with a flow rate in a range from 10 to 200 cubic meters per hour (e.g., 20 to 100, 30 to 50 cubic meters per hour).

The fluid can be directed using one or more fans.

The method can include generating electrical energy from solar energy and using the electrical energy to direct the recirculating stream and/or the humidity supply stream.

The method can include measuring one or more parameters related to the ambient environment (e.g., Temperature, RH) and varying a flow rate of the fluid in the recirculating stream based on the measurement.

The fluid can be air.

In general, in a further aspect, the disclosure features an atmospheric water harvesting device including: a humidity stream path arranged to receive air from an ambient environment to provide a humidity stream; a recirculating stream path for a recirculating stream of a fluid, the recirculating stream path being separated from the humidity stream path; a heating section in the recirculating stream path, the heating section being configured to heat the fluid in the recirculating stream path as it moves through the heating section during operation of the atmospheric water harvesting device; a rehumidification section in the recirculating stream path and in the humidity stream path, the rehumidification section being arranged to receive the fluid in the recirculating stream path from the heating section and configured to transfer moisture from the air in the humidity stream to the fluid in the recirculating stream during operation of the atmospheric water harvesting device; a condensing section in the recirculating stream path, the condensing section being configured to reduce the temperature of the fluid in the recirculating stream sufficient to cause condensation of water from the fluid during operation of the atmospheric water harvesting device; and a heat exchanger configured, during operation of the atmospheric water harvesting device, to transfer thermal energy from the fluid in the recirculating stream prior to the fluid entering the condensing section to the fluid in the recirculating stream after the fluid exits the condensing section.

Embodiments of the atmospheric water harvesting device can include one or more features of other aspects.

Among other advantages, the disclosed technology can be used to provide atmospheric water harvesting devices can be relatively inexpensive systems with a form factor sufficiently small for easy transport by an individual. For example, the systems can be formed from relatively low cost components and that can be folded up into a relatively small, relatively lightweight package.

The atmospheric water harvesting devices can be low power systems. For example, a relatively small photovoltaic cell can provide sufficient electrical power to run all the electrical components of the system.

In certain implementations, the atmospheric water harvesting devices can produce an amount of potable water adequate for at least one person's needs on a daily basis in environments with low relative humidity and modest amounts of sunshine. For example, embodiments of atmospheric water harvesting devices disclosed herein may produce approximately 5 liters of water per day in environments having a relative humidity as low as 30%, e.g., with 6 hours or more exposure to solar irradiance of 0.5 kW/m² or more (or equivalent power). The atmospheric water harvesting devices may generate such volumes with form factors that are sufficiently light and with sufficiently low volumes to be readily portable by an adult person, e.g., by motor vehicle, motorcycle, bicycle or on foot. Furthermore, the atmospheric water harvesting devices can be produced with a bill of materials and assembly processes that make them affordable to people in developing nations. Accordingly, it is believed that the atmospheric water harvesting devices can provide access to potable water for a significant portion of the world's population living without access to safely managed drinking water.

### BRIEF DESCRIPTION OF THE DRAWINGS

FIG. 1 is a schematic diagram of an example atmospheric water harvesting device.

FIG. 2 is a perspective view of an example desiccant wheel assembly.

FIGS. 3A-3D are schematic diagrams showing examples of heat exchangers that can be used in a recuperator section of an atmospheric water harvesting device.

FIG. 4 is a cross-sectional view of an example atmospheric water harvesting device.

Like labels in different drawings identify like elements.

### DETAILED DESCRIPTION

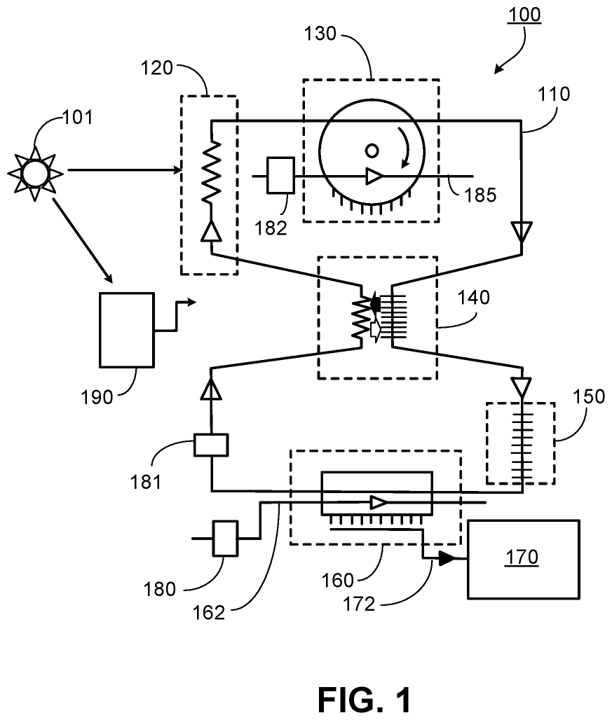

Referring to FIG. 1, an atmospheric water harvesting device (WHD) 100 that generates water from atmospheric water powered by solar energy 101. WHD 100 transfers water from the atmosphere via a humidity stream 185 or air drawn from an ambient environment to a recirculating stream 110 of a fluid, e.g., air. As explained in more detail below, recirculating stream 110 is heated then humidified with water vapor from humidity stream 185. Once humidified, recirculating stream 110 is cooled below the condensation point in order to cause the water vapor to condense for collection.

Recirculating stream 110 includes several sections including a heating section 120, a rehumidification section 130, a recuperator section 140, a heat sinking section 150, and a condenser section 160.

Heating section 120 serves to heat up the recirculating stream. The recirculating stream should be heating to a temperature sufficient to facilitate absorption of moisture in rehumidification section, discussed more below. While the temperature of the recirculating stream emerging from heating section 120 can vary depending on the particulars of the design and ambient conditions, generally, heating section 120 can heat the recirculating stream to 50° C. or more (e.g., 60° C. or more, 65° C. or more, 70° C. or more, 75° C. or more, 80° C. or more, e.g., 150° C. or less, 120° C. or less, 100° C. or less, 90° C. or less).

Generally, heating section 120 includes a solar heater which uses sunlight to heat up the fluid in the recirculating stream. Solar absorbers can include a layer of a material that absorbs solar radiation and converts the light to heat. For example, a solar absorber can include a panel of black material (e.g., a black paint) adjacent to a conduit for the recirculating stream. A window (e.g., a transparent plastic or glass) can be used to seal the conduit while allowing passage of light to the black material. The window can include a spectrally selective coating (e.g., for reflecting infrared wavelengths) in order to enhance greenhouse heating of the recirculating stream by trapping infrared radiation emitted by the black material.

In some embodiments, heating section 120 includes one or more layers of mesh material within the fluid flow volume. Multiple layers can be stacked on top of each other with sufficient space between adjacent layers to facilitate fluid flow. Generally, the mesh layers are arranged largely parallel to the air-flow, which can reduce (e.g., minimize) pressure drop. The one or more mesh layers can also include quilting, channels, grooves, and/or other geometries to help mix and equally distribute the fluid across the heated surfaces to improve performance. Parallel mesh layers (e.g., 1 to 10 layers total, such as 3-6 layers) can also be coated with spectrally selective coatings. Mesh materials can be metals (e.g., aluminum), plastics, or other fibers, in a woven or non-woven format. The mesh can be coated by a selective absorber material or paint to improve absorption of the full spectrum of sunlight without reflecting light back out, and reducing emission of infrared radiation. The mesh can increase the absorption and scattering of sunlight, and increase the heated surface area, fluid turbulence and uniform distribution for improved heat transfer performance. In some embodiments, both the mesh and the panel of black material can be coated with a selective absorber in order to enhance the heating of the recirculating stream by minimizing the emission of infrared radiation and maximizing the absorption of the full spectrum of sunlight. Generally, the recirculating stream can flow underneath the solar absorber panel as an alternative, or in addition, to above it.

In some embodiments, heating section 120 can include one or more blanket layers that further trap heat for heating the recirculating stream. For example, heating section 120 can include one or more stagnant or flowing gas layers between the recirculating stream and the ambient environment.

The rehumidification section 130 moves moisture from humidity stream 185 to recirculating stream 110. In some embodiments, rehumidification section 130 includes a cycled desiccant mechanism to move moisture from one stream to another. Specifically, a cycled desiccant mechanism includes a desiccant material that absorbs water from humidity stream 185 and subsequently desorbs the water upon exposure to recirculating stream 110. The desiccant material is cycled back and forth between the two streams, transferring moisture each cycle.

Generally, in a cycled desiccant mechanism, the transfer of moisture from one stream to the other is driven by a difference in temperature between the humidity stream and the recirculating stream. A relatively cool temperature, e.g., ambient temperature, e.g., below 45° C., the desiccant material predominantly adsorbs water from an air stream, even at relatively low relative humidity values, e.g., at or below 40% RH, such as 30% RH.

Cycled desiccant mechanisms can have a variety of suitable form factors. For example, cycled desiccant mechanisms can feature a solid desiccant material supported by a mesh on a wheel that rotates on its axis moving the desiccant between the two fluid streams. An example of such a desiccant wheel assembly is described in more detail below. Other arrangements are also possible. For instance, the desiccant material can be supported by a belt and rollers can be used to move the belt between the two fluid streams. In some embodiments, a cycled desiccant mechanism can include a cylinder or cone support for the desiccant material.

In some embodiments, unsupported desiccant material can be used. For instance, rather than provide a desiccant material on a solid support structure, a powdered or liquid desiccant can be used. In such arrangements, the desiccant material can be moved through a conduit between the two fluid streams. Desiccants in the form of beads can also be used.

Generally, a variety of appropriate desiccant materials can be used. For example, commercially-available desiccants can be used, including silica (e.g., solid or gel), alumina (e.g., solid or gel), activated carbon, salts (e.g., metal salts such as potassium salts and sodium salts, or organic salts), polymeric desiccants, zeolites, etc. In some embodiments, metal-organic framework based desiccants can be used. See, e.g., H. Kim, et al., Science 10.1126/science.aam8743 (2017), discussing the use of certain MOF-801 materials for water harvesting from air.

Condenser section 160 reduces the temperature of recirculating stream 110 to a temperature below its dew point such that liquid water condenses. In order to perform such a function, generally condenser section 160 includes a heat exchanger that removes thermal energy from the recirculating stream by passive thermal contact with air at ambient temperature. Typically, such a heat exchanger includes a conduit for the recirculating stream separated from air by a barrier that facilitates transfer of thermal energy from the recirculating stream to the air. The air can be ambient air e.g., where one side of the heat exchanger is open to the ambient environment or the air can be drawn from the ambient environment through ducts to the heat exchanger. In some embodiments, heat exchange can be provided by bringing the recirculating stream into thermal contact with the ambient environment using a large foil separator between the two fluid streams.

In condenser section 160, the velocity and/or pressure of the recirculating stream and ambient air can be the same or different. For example, the velocity of the air on one side of the heat exchanger can be faster than the velocity of the recirculating stream. Such a velocity differential can advantageously enhance the cooling effect.

Generally, condenser section 160 includes ducts 172 for collecting and funneling condensed water to a container 170. The ducts can include a hydrophobic coating to shed condensed water. Alternatively, or additionally, the ducts can include a bioinhibitor coating to reduce (e.g., prevent) unwanted biological growth, e.g., algae and/or bacterial growth. The condenser section can be configured so that the liquid water drains into a container under gravity.

The function of recuperator section 140 is to reuse heat in recirculating stream 110 by facilitating heat exchange between the hot fluid coming from rehumidification section 130 and the cold fluid exiting condenser section 160. Here, the terms “hot” and “cold” are relative terms, referring only to the relative temperature difference between the fluid in different portions of the recirculating stream. As noted previously, even in its coolest sections, the recirculating stream can be 40° C. or more.

In order to perform its function, recuperator section 160 includes a heat exchanger that removes thermal energy from the hot recirculating stream in one area and transfers the thermal energy to a cold portion of the recirculating stream by passive thermal contact. Typically, such a heat exchanger includes a conduit for the hot recirculating stream and a conduit for the cold recirculating stream where the two conduits are separated by a barrier that facilitates transfer of thermal energy from the hot recirculating stream to the cold. The conduit for the hot recirculating stream receives fluid exiting rehumidification section 130 and delivers this fluid to the condensing section 160 (e.g., by way of heat sinking section 150, in certain embodiments). The conduit for receiving the cold recirculating stream receives fluid exiting condenser section 160 and delivers this fluid to the reheating section 120. Example arrangements for the heat exchanger are described below.

In some embodiments, recuperator section 160 facilitates heat recuperation by moving thermal mass between the humidity stream and the recirculating stream, e.g., using an enthalpy wheel.

Heat sinking section 150 further reduces the temperature of recirculating stream 110 after it exits recuperator section 140. Generally, heat sinking section 150 performs this function by passive thermal contact with air at ambient temperature, in much the same way as condenser section 160 described above. Here, the thermal contact is considered passive because the thermal energy is transferred by heat sinking section 150 without additional sources of energy (e.g., electrical energy) to facilitate the thermal transport. In certain embodiments, heat sinking section 150 and condenser section 160 are formed by a continuous structure, e.g., a heat exchanger. In a thermodynamic sense, heat sinking section 150 serves just to reduce the temperature of the recirculating stream from recuperator section 140, i.e., by removal of sensible heat, while condenser section 160 removes thermal energy in the form of latent heat to cause water condensation. Condenser section 160 can also remove sensible heat from the recirculating stream. In general, heat sinking section 150 is optional and embodiments of WHD 100 can operate adequately without one.

WHD 100 also includes blowers 181 and 182 to move the fluid in recirculating stream 110 and humidity stream 185. Furthermore, WHD 100 can include a blower 180 arranged to provide airflow from the ambient environment through condenser section 160. In general, any suitable blower capable of providing a desirable level of fluid flow through the respective stream can be used. Fans, for example, can be used as a blower. Ideally, the blowers should have relatively low electrical power requirements.

WHD 100 generates electrical power via a photovoltaic module 190. The photovoltaic module powers, for example, blowers 180, 181, and 182, and any other components that utilize electrical power, such as moving components of rehumidification module 130 (e.g., a cycled desiccant mechanism).

Generally, WHD 100 can be implemented to realize numerous advantages. For example, WHD 100 can be implemented in form factors that are relatively compact, light, and inexpensive. Furthermore, WHD 100 can be powered exclusively by solar energy, allowing for effective operation without access to an electric grid. Accordingly, WHD 100 has the potential to be affordable and used by lower income people in rural and/or locations without sufficient water or power infrastructure development.

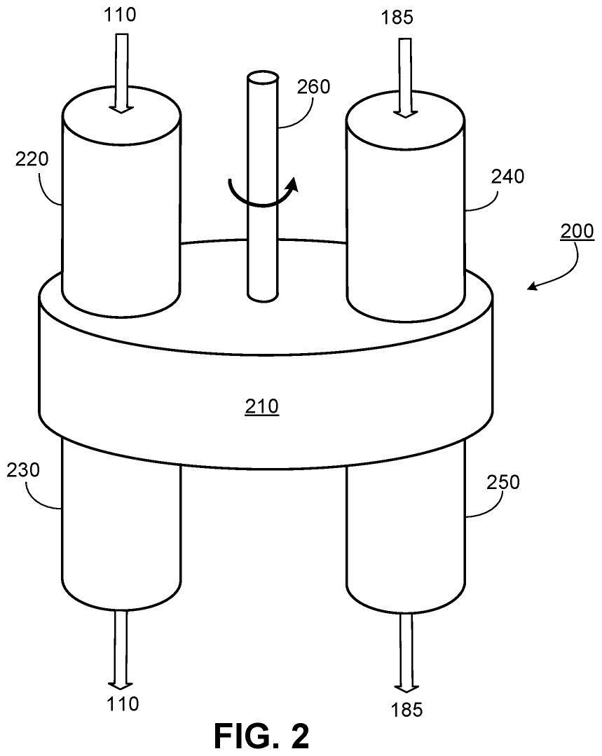

Referring to FIG. 2, as noted previously, in some embodiments, rehumidification section 130 can include a desiccant wheel assembly 200 that rotates a solid desiccant material between recirculating stream 110 and humidity stream 185. The solid desiccant material is supported on a wheel 210 connected to a rotary actuator 260 that rotates wheel 210 on its axis. Wheel 210 includes a support structure, e.g., a mesh that supports a solid desiccant material and also provides channels for fluid flow through the wheel. The support structure can be designed to provide a large surface area for supporting desiccant material with channels of sufficient size and density to allow fluids to readily flow through the wheel at pressures consistent with those in the recirculating stream and humidity stream.

An inlet 220 (e.g., a tube or other conduit) delivers fluid in recirculating stream 110 to one area of wheel 210. This fluid is collected at an outlet 230 (e.g., a tube or other conduit) on the opposite side of wheel 210. Although cylindrical tubes are depicted, more generally other forms of conduits can be used. For example, funnels can be used at inlet 220 and/or outlet 230 to provide, deliver, and/or capture the fluid.

Similarly, an inlet 185 and an outlet 250 are arranged to deliver and collect humidity stream 185 at a different area of wheel 210. Accordingly, continuous rotation of wheel 210 continuously moves portions of the wheel back and forth between the recirculating stream and the humidity stream.

Variations of desiccant wheel assembly 200 are possible. For example, in the foregoing embodiment, each fluid stream is directed through wheel 210 once. In some cases, recirculating stream 110 and/or humidity stream 110 can be passed through wheel 210 more than once (e.g., twice, three times or more). For example, outlet 230 and/or outlet 250 can be U-shaped to direct their respective streams back to a different area of wheel 210 and a further conduit positioned to receive the fluid as it passes through wheel 210 for the second time.

In some cases, a desiccant wheel assembly can include separate conduits for wheel heat recuperation. For instance, the harvesting device can recuperate heat from the wheel (e.g., as the wheel exits the recirculating stream where water is desorbed) for reheating the recirculating fluid in a section of the recirculating stream after condenser section 160 but before rehumidification section 130. Alternatively, or additionally, hot recirculating stream fluid can be used to preheat cold portions of the wheel prior to those portions entering the desorption zone of the recirculating stream.

In some embodiments, WHD can include more than one desiccant wheel assembly. For example, multiple desiccant wheel assemblies can be arranged in series so that the recirculating stream passes through more than one wheel. Each wheel can have a separate humidity stream or the same humidity stream can be passed through each wheel.

Other cycled desiccant mechanisms besides a wheel assembly are also possible. For example, cycled desiccant mechanisms can take the form of a belt, a cylinder, or a cone. In some embodiments, the desiccant material can be in the form of individual beads that can be moved between the two fluid streams. Desiccant material can also be in a powder or liquid form.

Furthermore, while the aforementioned cycled desiccant mechanism involves moving a desiccant material between two fluid streams that remain in fixed positions, in some cases the fluid streams can be redirected to different areas of desiccant material. For example, the WHD can include

Generally, recuperator section 140 can be implemented in a variety of suitable forms to facilitate transfer of thermal energy from the hot fluid in the recirculating stream to the cold fluid in the recirculating stream. Typically, thermal transfer is facilitated by a heat exchanger placing hot recirculating stream fluid in thermal contact, via a barrier, with cold recirculating stream fluid. The conduits containing the streams are generally arranged to maintain thermal contact between the hot and cold streams for sufficient time and over a sufficiently large area to enable significant transfer of thermal energy. The barriers forming the conduits are typically formed from materials that are impermeable to the fluid, but have relatively good thermal conduction properties to facilitate heat flow between the fluid bodies. Thin metal sheets (e.g., copper or steel sheets) or certain plastic barriers can be used.

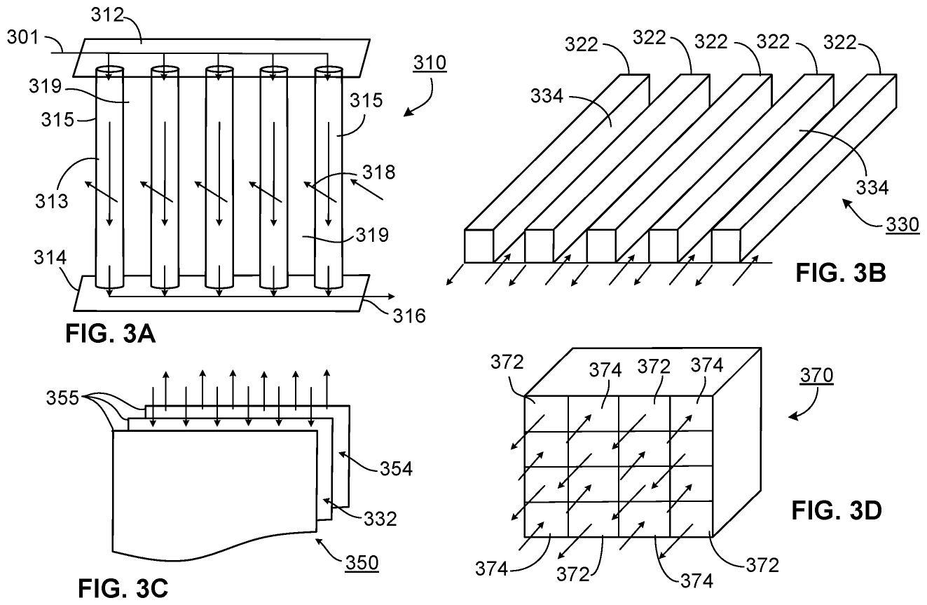

A variety of flow geometries are possible. For example, referring to FIG. 3A, in some embodiments, a recuperator section includes a heat exchanger 310 in which one stream 301 (e.g., the hot or the cold stream) is directed through a manifold that includes multiple parallel conduits 315 linking an inlet channel 312 to an outlet channel 314. The other stream flows through spaces 319 between conduits 315, as indicated by arrows 318. Of course, while only five parallel conduits 315 are illustrated, in general, the number of conduits, as well as their length, bore, and spacing is determined according to the desired flow rate, thermal transfer rate, and form factor requirements, for example.

Heat exchanger 310 is an example of a heat exchanger using a cross-flow arrangement, where the flow direction of one stream is orthogonal to the other. Other flow arrangements are also possible. For example, in some embodiments counter-flow heat-exchangers are possible. An example of a counter-flow arrangement is shown in FIG. 3B, which shows a heat exchanger 330 composed of a first set of parallel conduits 332 containing a first stream separated by a second set of parallel conduits 334 containing the second stream. As illustrated by the arrows, each respective set of conduits carries fluid streams moving in a parallel direction, opposite to the direction of the streams in the other set of conduits. The number of conduits shown is purely illustrative. Generally, the number of conduits and dimensions can be selected according to the factors discussed above in relation to heat exchanger 310.

In some embodiments, the heat exchanger can include planar conduits for the fluid streams. Generally, such conduits can expose the streams in adjacent conduits to a larger relative surface area for thermal transfer than, e.g., conduits with a cylindrical shape or a square channel cross-section. For example, referring to FIG. 3C, a heat exchanger 350 includes planar conduits 352 and 354, each containing streams moving in opposite directions, formed from three planar barrier films 355 arranged parallel to each other. Additional planar channels can be formed using additional similar planar barrier films.

In some embodiments, the heat exchanger can include channels stacked in two dimensions. For example, referring to FIG. 3D, a heat exchanger 370 includes channels 372 and channels 374 arrayed in two dimensions. Channels 372 carry one stream of fluid in one direction, while channels 374 carry the other stream in the opposite direction.

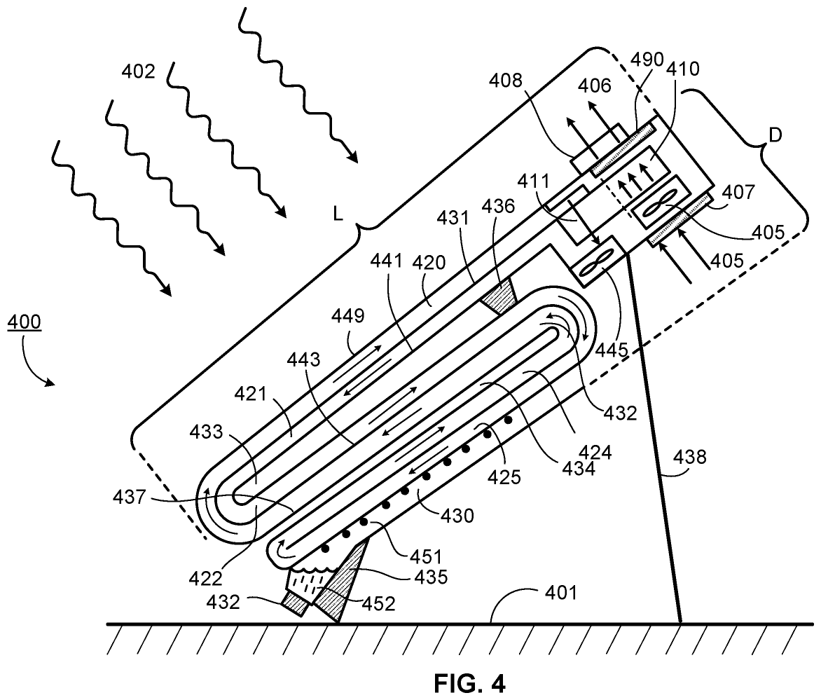

While WHD 100 can be implemented in a variety of form factors, an example WHD is shown in FIG. 4, which shows an example WHD 400 in cross-section. WHD 400 is a portable, continuous mode WHD that is solar powered. It is repositionable on a surface 401 (e.g., the ground or a rooftop) via feet 435 and an adjustable kickstand 438, allowing a user to relocate and reorient the WHD so that the top surface 419 of the WHD faces the sun to receive incoming solar radiation 402.

Upon collapsing kickstand 438, WHD 400 fits within a rectangular volume having a length L, a depth D, and a width W (into the plane of the figure), which may be relatively small. For example, the volume may be sufficiently small so that WHD can be transported on the back of a truck, in the trunk of a car, or even carried on a motorcycle or bicycle. Typically, the depth D is less than L and W. W can also be less than L. In some embodiments, L is about 2 m or less (e.g., about 1.5 m or less, about 1.25 m or less, about 1 m or less, about 90 cm or less, about 80 cm or less), W is about 1.5 m or less (e.g., about 1.25 m or less, about 1 m or less, about 90 cm or less, about 80 cm or less, about 70 cm or less, about 60 cm or less, about 50 cm or less), and D is about 50 cm or less (e.g., about 40 cm or less, about 30 cm or less, about 20 cm or less).

WHD 400 can be relatively light. For example, WHD 400 can weigh about 50 kg or less (e.g., about 40 kg or less, about 30 kg or less, about 20 kg or less). For instance, WHD 400 can be sufficiently light so to be readily carried by a typical adult person.

Generally, the surface area of WHD 400 that receives solar radiation 402 has an area corresponding to L x W, which can be about 2 m² or less (e.g., 1.5 m² or less, 1 m² or less).

WHD 400 includes a recirculating stream section composed of three planar portions folded on top of each other. Each of these portions includes two channel layers, one carrying the recirculating fluid (e.g., air) towards a desiccant wheel 410 and one carrying the recirculating fluid away from the wheel. Each channel layer includes one or more channels that carry the recirculating fluid. The channels can snake back and forth into the plane of the figure. Each section of a channel in a layer can be separated by a baffle, for example. Generally, the shape, bore, and length of a channel in each layer is selected according to a desired flow rate of the recirculating fluid and the thermodynamics of the system (e.g., the thermal cooling or heating desired in a particular portion of the recirculating stream). In some embodiments, the recirculating fluid can be directed through the channels at a flow rate in a range from 0 to 200 cubic meters per hour (e.g., 20 to 100 cubic meters per hour, 30 to 50 cubic meters per hour).

Specifically, the top portion includes a first channel layer 420 carrying the recirculating fluid towards wheel 410 and a second channel layer 421 carrying the recirculating fluid away from the wheel. The middle portion includes a first channel layer 422 carrying the recirculating fluid away from wheel 410 and a second channel layer 423 carrying the recirculating fluid towards the wheel. The lower portion includes a first channel layer 425 carrying recirculating fluid toward wheel 411 and a second channel layer 425 carrying the recirculating fluid away from the wheel. Together, the channels in these layers form a continuous fluid path to and from the desiccant wheel, providing the functional sections for repeatedly heating and cooling the recirculating fluid and condensing water from the fluid stream as described for WHD 100 above. The path generally confines the flow of the stream from the ambient environment and may be established by ducts, channels, pipes, and other fluid conduits, including conduits that are within and/or between various functional sections of the system.

The uppermost portion corresponds to the heating section of WHD 400, where dry recirculating fluid in channel 420 is heated to its highest temperature before reaching the desiccant wheel. To facilitate this heating, the upper barrier for the portion (providing surface 419) is formed from a material that is substantially transparent to solar radiation 402, transmitting the incident sunlight into channel 420 where it can heat the fluid. For example, this barrier can be formed by a transparent plastic material that is both durable to the elements and transparent to sunlight. Furthermore, the barrier 431 separating channel layer 420 from channel layer 421 can include a light absorbing material (e.g., a black layer) to absorb the solar radiation and reradiate the absorbed energy as infrared radiation, which can further heat the recirculating fluid in channel layer 420.

The middle portion (composed of channel layers 422 and 423) corresponds to the recuperating section of the WHD where heat is transferred from the hot, humid recirculating fluid in channel 422 to cool, dry fluid in channel 423. A barrier film 443 between these channel layers, while being impermeable to the fluid, provides thermal contact between the recirculating fluid in the two channel layers facilitating flow heat between the two fluid bodies.

Water condensation occurs in the lowermost portion (channels 424 and 425), which is adjacent to a water flow channel 430 which collects condensate 451 that diffuses through a semipermeable film forming the outer wall of channel 425. Under gravity, condensate runs down channel 430 and pools in a reservoir 452, providing a trap for the condensate. A user can access this water via a capped spout 432, which provides access to reservoir 452.

WHD 400 includes spacers to provide insulating air gaps between the folded portions. In particular, a spacer 436 provides a standoff distance between the top portion (with channel layers 420 and 421) and middle portion (with channels 422 and 423). Spacer 436 results in an air gap 433 between channel layer 421 and channel layer 422, reducing thermal transfer between these channel layers. Similarly, another spacer 437 provides a standoff distance between the middle portion and the lower portion (with channels 424 and 425), yielding an air gap 434 between channel layers 423 and 424.

At one end, the channels in layer 420 and in layer 421 respectively deliver dry, heated recirculating fluid to desiccant wheel 410 and receive humid, heated fluid from the wheel. The fluid path through wheel 410 is shown by arrow 411 in FIG. 4. A blower 415 (e.g., with one or more fans), located near wheel 410, draws the recirculating fluid through the wheel and maintains the flow of the recirculating fluid through channel layers 420-425. The size and weight of the desiccant wheel is generally selected based on the desired sorption rate/water output for the WHD, balanced with maintain a relatively compact and light form factor. In some embodiments, the filter wheel can contain 5 kg or less (e.g., 2 kg or less, 1 kg or less, 0.5 kg or less) of a desiccant material, such as a silica or zeolite desiccant material.

An actuator (not shown) rotates desiccant wheel 410 to continuously vary the portion of the wheel exposed to the recirculating fluid. Generally, the rate of rotation can be selected to optimize water desorption from the wheel. The rotation rate can be 1 rpm or less (e.g., 0.1 rpm or less). Typically, the wheel will rotate multiple times each day during operation.

A second blower 412 draws ambient air 405 into an inlet port 407 and blows the air through the desiccant wheel 410 where the wheel absorbs moisture from the air. Optionally, inlet port 407 includes an air filter to reduce debris and dust from entering and possibly clogging the ducts that carry the air to desiccant wheel 410 and/or clogging the channels through desiccant wheel 410.

Dry air 406 exiting the desiccant wheel is exhausted back into the environment through an exhaust port 408, which may also include a filter or other barrier to prevent entry of debris into the ducts.

Blowers 412 and 415 and the actuator (not shown) driving desiccant wheel 410 are electrically powered by one or more photovoltaic cells 490 located on a top surface of WHD 400, positioned to receive solar radiation 402. Generally, the size and number of photovoltaic cells can vary depending on the power demands of the WHD. In some embodiments, sufficient photovoltaic cells are provided to generate 10 Watts or more (e.g., 20 W or more, 50 W or more, 100 W or more, e.g., up to 1 kW or less) of power under typical operating conditions (e.g., 1 kW/m² of solar radiation).

In general, the volume, mass, and specific geometry and composition of the components of WHD 400 are chosen to provide a desired level of production. In some embodiments, WHD 400 is designed to generate at least 1 liter of water per day (e.g., 2 liters or more per day, 3 liters or more per day, 5 liters or more per day) under conditions where it is exposed to at least 0.5 kW/m² of solar radiation for at least 6 hours at a relative humidity of 30% or more. Under such conditions, in certain embodiments, WHD 400 can generate less than 10 liters of water per day.

WHD 400 can collect water at a rate of 100 ml/hour or more (e.g., 120 ml/hour or more, 150 ml/hour or more, 200 ml/hour or more, 300 ml/hour or more, 400 ml/hour or more) per square meter of exposure to solar energy when exposed to at least 0.5 kW/m² of solar radiation.

In some embodiments, electricity generated using the photovoltaic cell can be used to disinfect collected water. For example, the generated electricity can be used to disinfect collected water through powering ozone or UV generating devices that pass the treatment through the collected water, Alternatively, or additionally, solar energy can be used directly to disinfect the collected water. For example, the water can be exposed to sufficient solar UV irradiation and/or brought to a sufficient temperature through solar thermal energy to sterilize the water. In some embodiments, chemical treatments such as chlorination, bromination, or similar chemicals can be used to sterilize the water. In certain embodiments, water-wetted surfaces can incorporate sterilizing chemicals or materials, for example, silver or/and or copper particles.

In general, a number of embodiments have been described. However, variations are possible. For example, while WHD 400 has a recirculating stream composed of three portions folded on top of each other, additional folded portions can be included. For example, if the path of the channels for the recirculating stream is to be lengthened, while the footprint of the WHD (i.e., L×W) is to remain under a certain limit, the number of folded portions can be increased (e.g., to five or more, to seven or more, nine or more). Alternatively, or additionally, while desiccant wheel 410, photovoltaic cells 490, blowers 412 and 415 are housed at the top end of WHD 400, other placement of these components is also possible. For example, they can be placed over feet 435 near the bottom of the WHD, which may improve stability of the device.

In some embodiments, WHD 400 can include a battery for storing electrical power to continue to extract water after sun sets or when the weather is too cloudy to provide enough electrical power for adequate operation. Alternatively, or additionally, a socket for connection to an external power source can be provided. Circuitry to facilitate switching operation between NC and D/C power sources is also possible, to facilitate operating with different sources of power. In some embodiments, the battery can be used to provide electric power for other household applications, such as lighting.

Other embodiments are in the following claims.

1. An atmospheric water harvesting device comprising:
a humidity stream path arranged to receive air from an ambient environment to provide a humidity stream;
a recirculating stream path for a recirculating stream of a fluid, the recirculating stream path being separated from the humidity stream path;
a heating section in the recirculating stream path, the heating section being configured to heat the fluid in the recirculating stream path as it moves through the heating section during operation of the atmospheric water harvesting device;
a rehumidification section in the recirculating stream path and in the humidity stream path, the rehumidification section being arranged to receive the fluid in the recirculating stream path from the heating section and configured to transfer moisture from the air in the humidity stream to the fluid in the recirculating stream during operation of the atmospheric water harvesting device;
a condensing section in the recirculating stream path, the condensing section being configured to transfer thermal energy from the fluid in the recirculating stream sufficient to cause condensation of water from the fluid during operation of the atmospheric water harvesting device; and
a recuperator section in the recirculating stream path, the recuperator section being configured, during operation of the atmospheric water harvesting device, to transfer thermal energy from the fluid in the recirculating stream prior to the fluid entering the condensing section to the fluid in the recirculating stream after the fluid exits the condensing section.

2. The atmospheric water harvesting device of claim 1, wherein the heating section comprises a solar heater.

3. The atmospheric water harvesting device of claim 2, wherein the solar heater comprises a sunlight absorbing material exposed to ambient radiation and in thermal contact with the recirculating stream path in the heating section.

4. The atmospheric water harvesting device of claim 3, wherein the solar heater comprises a transparent window separating the recirculating stream from the ambient environment and the transparent window comprises one or more spectrally selective coatings configured to reduce loss of heat by infrared radiation from the recirculating stream in the heating section to the ambient environment.

5. (canceled)

6. The atmospheric water harvesting device of claim 2, wherein the heating section comprises one or more stagnant blanket layers configured to reduce thermal losses of the recirculating stream in the heating section.

7. The atmospheric water harvesting device of claim 2, wherein the heating section comprises one or more flowing blanket layers configured to reduce thermal losses of the recirculating stream in the heating section and the one or more flowing layers comprise fluid from the recirculating stream after the fluid has exited the rehumidification section.

8. (canceled)

9. The atmospheric water harvesting device of claim 1, wherein the recirculating stream path comprises a first space that operates at a first pressure above a neighboring space or above ambient pressure, the first space being in fluid communication with another space that operates at a pressure closer to the first space than the pressure of the neighboring space or ambient pressure and balances pressure-induced forces on one or more layers bounding the first space.

10. The atmospheric water harvesting device of claim 1, further comprising one or more layers of a mesh material in the recirculating stream path arranged in the recirculating stream path in the heating section.

11. (canceled)

12. The atmospheric water harvesting device of claim 1, wherein the rehumidification section comprises a cycled desiccant mechanism to facilitate transfer of moisture from the humidity stream to the recirculating stream during operation of the atmospheric water harvesting device.

13. The atmospheric water harvesting device of claim 12, wherein the cycled desiccant mechanism comprises an assembly comprising a desiccant material and a motor configured to move the desiccant material between the path of the recirculating stream and the path of the humidity stream,
wherein the assembly is a desiccant wheel assembly configured to rotate the desiccant material between the path of the recirculating stream and the path of the humidity stream or the assembly comprises a support for the desiccant material, the support being selected from the group consisting of a belt, a cylinder, or a cone.

14-15. (canceled)

16. The atmospheric water harvesting device of claim 1, wherein a first portion of the recuperator section is located in the recirculating stream path immediately downstream from the rehumidification section and immediately upstream from the condensing section and a second portion of the recuperator section.

17. The atmospheric water harvesting device of claim 16, wherein a second portion of the recuperator section is located in the recirculating stream path immediately upstream from the condensing section and immediately downstream from the heating section.

18. The atmospheric water harvesting device of claim 1, wherein the recuperator section comprises a heat exchanger module comprising a first flow path for the recirculating stream and a second flow path for the recirculating stream separated from the first flow path, the first flow path being arranged in the recirculating stream path downstream from the rehumidification section and upstream from the condensing section, and the second flow path being arranged in the recirculating stream path downstream from the condensing section and upstream from the rehumidification section.

19. The atmospheric water harvesting device of claim 1, wherein the recuperator section comprises a foil separating fluid in the recirculating stream path downstream from the rehumidification section and upstream from the condensing section from fluid in the recirculating stream path downstream from the condensing section and upstream from the rehumidification section.

20. The atmospheric water harvesting device of claim 1, wherein the condensing section is configured to transfer thermal energy from the fluid in the recirculating stream by transferring thermal energy from the fluid to external environmental air at an ambient temperature.

21-23. (canceled)

24. The atmospheric water harvesting device of claim 1, further comprising a heat sinking section arranged in the recirculating stream path between the recuperator section and the condensing section, the heat sinking section being configured to transfer thermal energy from the fluid in the recirculating stream to an ambient environment.

25. (canceled)

26. The atmospheric water harvesting device of claim 1, further comprising one or more blowers to move the fluid through the recirculating stream path.

27. The atmospheric water harvesting device of claim 1, further comprising a water trap to facilitate extraction of liquid water condensed in the condensing section.

28. The atmospheric water harvesting device of claim 1, further comprising a photovoltaic module configured to provide electrical power to the atmospheric water harvesting device.

29. The atmospheric water harvesting device of claim 1, wherein the harvesting device has a mass of 50 kg or less.

30. A method for harvesting water from air, the method comprising:
directing a fluid continuously in a recirculating stream;
heating the fluid in a first section of the recirculating stream;
after heating the fluid, transferring water from a humidity stream to the fluid in a second section of the recirculating stream, the humidity stream comprising air from an ambient environment;
after transferring the moisture to the fluid in the recirculating stream, cooling the fluid sufficiently to cause condensation of liquid water from the fluid in a third section of the recirculating stream;
collecting the liquid water; and
directing the fluid from the third section of the recirculating stream back to the first section of the recirculating stream,
wherein cooling the fluid and heating the fluid comprises transferring thermal energy through a fluid barrier from the fluid in the third section to the fluid in the first section.

31-48. (canceled)
